(19) United States
(12) Patent Application Publication
(10) Pub. No.: US 2016/0308261 A1
(43) Pub. Date: Oct. 20, 2016

(54) ZERO LEAD POLLUTION PROCESS FOR RECYCLING USED LEAD ACID BATTERIES

(71) Applicant: VERDEEN CHEMICALS, INC., Wilmington, DE (US)

(72) Inventors: Vipin TYAGI, Houston, TX (US); Sanjeev TYAGI, Ghaziabad (IN)

(73) Assignee: VERDEEN CHEMICALS, INC., Wilmington, DE (US)

(21) Appl. No.: 15/101,894

(22) PCT Filed: Dec. 3, 2014
(86) PCT No.: PCT/US2014/068350

§ 371 Date: Jun. 3, 2016

Related U.S. Application Data
(60) Provisional application No. 61/911,054, filed on Dec. 3, 2013.
(60) Provisional application No. 62/057,376, filed on Sep. 30, 2014.

(51) Int. Cl. H01M 10/54; C01G 21/06; B01J 19/18; C22B 3/02; C22B 3/00; H01M 10/06; C22B 3/16

(52) U.S. Cl. CPC H01M 10/54; H01M 10/06; C01G 21/06; C22B 3/165; C22B 3/02; C22B 13/045; B01J 19/1862; B01J 2219/0004

(57) ABSTRACT

Described herein is a process for recycling of used lead-acid batteries. In an embodiment, the process includes contacting crushed non-metallic components with a reducing mixture comprising a nitric acid solution to reduce at least a portion of residual lead compounds and alloys. The lead in the portion of residual lead compounds and alloys is reduced from an insoluble +4 state to a soluble +2 state to form a slurry with a lead-rich filtrate. The process further includes filtering the slurry to separate plastics and separators from the lead-rich filtrate and contacting the lead-rich filtrate with sulfuric acid to obtain a lead sulfate paste and nitric acid. The process further includes processing the metal containing components to form a paste comprising sulfates of lead and other metals present in the metal containing components, contacting the lead sulfate paste and the paste comprising sulfates of lead and other metals with alkali to form a precipitate comprising oxides of lead, and contacting the precipitate comprising oxides of lead with a carboxylic acid to form soluble lead carboxylates. Soluble lead carboxylates are then processed to obtain lead monoxide.

### REFERENCE TO RELATED APPLICATIONS

This application claims priority to U.S. Provisional Application No. 61/911,054, filed Dec. 3, 2013 and U.S. Provisional Application No. 62/057,376, filed Sep. 30, 2014. The entire contents are incorporated by reference herein.

### TECHNICAL FIELD

This disclosure relates to the recycling of spent lead-acid batteries without smelting and recovering lead in metal and oxides form.

### BACKGROUND

The global lead demand is estimated to be 10.5 million ton (1 ton equals 1000 kilograms) or about $21.6 bn and is expected to grow at greater than 4% per year. About 50% of this demand is met through recycling of spent lead-acid batteries (LABs) and the rest through mining. About 80% of the 10.5 million ton lead demand is used to manufacture new LABs, which are used in a wide variety of applications like automobiles, backup power supply, aircrafts, submarines etc. These batteries can typically be classified as either flooded or valve regulated lead acid batteries (VRLA). In flooded batteries, distilled water needs to be regularly added to the battery. VRLA batteries on the other hand are sealed and do not require any maintenance.

The LABs are the most recycled item globally (in percentage terms) but the recycling process, based on smelting, is extremely polluting, energy intensive and hazardous. The governments around the world making stricter environmental regulations, which is making recycling increasingly expensive. Due to these factors, a cleaner, cheaper and a faster process for recycling of LABs is desired.

### BRIEF DESCRIPTION OF DRAWINGS

In the present disclosure, reference is made to the accompanying drawings, which form a part hereof. In the drawings, similar symbols typically identify similar components, unless context dictates otherwise. Various embodiments described in the detailed description, drawings, and claims are illustrative and not meant to be limiting. Other embodiments may be used, and other changes may be made, without departing from the spirit or scope of the subject matter presented herein. It will be understood that the aspects of the present disclosure, as generally described herein, and illustrated in the Figures, can be arranged, substituted, combined, separated, and designed in a wide variety of different configurations, all of which are contemplated herein.

FIG. 1 depicts a schematic of a process for producing lead oxide from spent lead-acid batteries, according to an embodiment of the present disclosure.

FIG. 2A depicts a schematic of a process for recovering the lead and lead compounds stuck on the non-metallic components, in accordance with an embodiment disclosed herein.

FIG. 2B depicts a schematic of an alternate process for recovering the lead and lead compounds stuck on the non-metallic components, in accordance with an embodiment disclosed herein.

FIG. 3 depicts a schematic of a process for producing lead oxide from paste obtained from positive plates from spent lead-acid batteries, according to an embodiment of the present disclosure.

FIG. 4 depicts a schematic of a process for producing lead oxide from paste obtained from negative plates from spent lead-acid batteries, according to an embodiment of the present disclosure.

FIG. 5 depicts a schematic of a plant for producing lead oxide from spent lead-acid batteries, according to an embodiment of the present disclosure.

### DESCRIPTION OF EMBODIMENTS

Before the present methods and systems are described, it is to be understood that this disclosure is not limited to the particular processes, methods and devices described herein, as these may vary. It is also to be understood that the terminology used herein is for the purpose of describing the particular versions or embodiments only, and is not intended to limit the scope of the present disclosure which will be limited only by the appended claims. Unless otherwise defined, all technical and scientific terms used herein have the same meanings as commonly understood by one of ordinary skill in the art.

It must also be noted that as used herein and in the appended claims, the singular forms “a”, “an”, and “the” include plural reference unless the context clearly dictates otherwise. Thus, for example, reference to a “battery” is a reference to one or more batteries and equivalents thereof known to those skilled in the art, and so forth. Nothing in this disclosure is to be construed as an admission that the embodiments described in this disclosure are not entitled to antedate such disclosure by virtue of prior invention. As used in this document, the term “comprising” means “including, but not limited to.”

Described herein is a process for recovering and manufacturing of lead oxides and refined lead from spent lead-acid batteries. The process described herein is generally used for recycling used lead acid batteries with 100% lead recovery (in form of high purity lead metal and lead oxides) and with minimal lead pollution.

In an embodiment, the process can be used to manufacture high purity (greater than 99.99%) lead metal recovered from the used lead acid batteries. In an embodiment, the process can further be used to manufacture high purity (greater than 99.99%) lead monoxide (PbO), high purity (greater than 99.99%) lead dioxide (greater than PbO₂), or high purity (greater than 99.99%) red lead (Pb₃O₄), in which the percentage of lead dioxide (PbO₂) can be accurately controlled, from a paste obtained from used lead acid batteries. In some embodiments, the red lead obtained from this process may be, for example, jointing grade (15.1-25.1% PbO₂), setting grade (25.2-33.2% PbO₂) or non-setting grade (33.3+% Pb^{O}₂) red lead with accurate control of lead dioxide percentage.

Furthermore, in an embodiment, the process may be used to manufacture a high purity (greater than 99.99%) “pre-sulfated” lead oxide (a.Pb.×PbO.yPbO₂.zPbSO₄), in which the percentage of free lead (Pb) (“a”, up-to 35%), lead monoxide (PbO) (“x”, up-to 80%), lead dioxide (PbO₂) (“y”, up-to 34%), and lead sulfate (PbSO₄) (“z”, up-to 15%) can be accurately controlled. It should be noted out that the percentages of the individual components (Pb, PbO, PbO₂ and PbSO₄) could be zero as well.

Additional uses of the process disclosed herein include, but are not limited to, manufacturing of positive and/or negative plates for a lead acid battery with the “pre-sulfated” lead oxide, or manufacturing of “pre-sulfated” lead oxide paste used in making positive and/or negative electrodes for lead acid batteries. Using the “pre-sulfated” lead oxide paste to prepare the positive and/or negative battery plates manufactured by the process described herein substantially reduces the time required for lead acid battery plate.

An embodiment described herein provides an economical and a clean process with zero discharge and waste to recover very pure (greater than 99.99%) lead metal and lead oxides from used (alternatively referred to herein as “spent”) lead acid batteries and substantially reduce the manufacturing time of lead oxides (lead monoxide, lead dioxide, red lead and “pre-sulfated” oxide) from used lead acid batteries.

An embodiment described herein can be used to accurately control the percentage of sulfate (SO₄²⁻) ions in the form of lead sulfate (PbSO₄) in the mixture of lead oxides obtained after treatment of the paste, obtained from used lead acid batteries, with the preferred alkali solution. Some embodiments described herein allow for recovery of non-lead metallic impurities (example barium, antimony, calcium, tin, arsenic, selenium, bismuth, cadmium), in form of their hydroxides and sulfates, from spent lead acid batteries.

An embodiment described herein provides two methods for recovering lead stuck on battery plate separators both—Absorbed Glass Mat (AGM) and polyethylene (PE)—of spent lead acid batteries via: (a) treatment with an alkali, sulfuric and acetic acid; and (b) treatment with hydrogen peroxide and nitric acid.

An embodiment described herein provide two methods for recovering lead and lead compounds stuck on containers and top lid of spent lead acid batteries via: (i) treatment with sulfuric and acetic acid; and (ii) treatment with hydrogen peroxide and nitric acid.

Another embodiment described herein provides a method of controlling the de-sulfurization of the paste using an alkali solution, preferably hydroxides or carbonates of sodium or potassium, by optimizing the reaction time, reaction temperature and alkali concentration.

Yet another embodiment described herein provides a method of controlling the de-sulfurization of the paste by treating it with an alkali solution, preferably hydroxides or carbonates of sodium or potassium, in multiple stages, by controlling the reaction time, reaction temperature and alkali concentration in each stage.

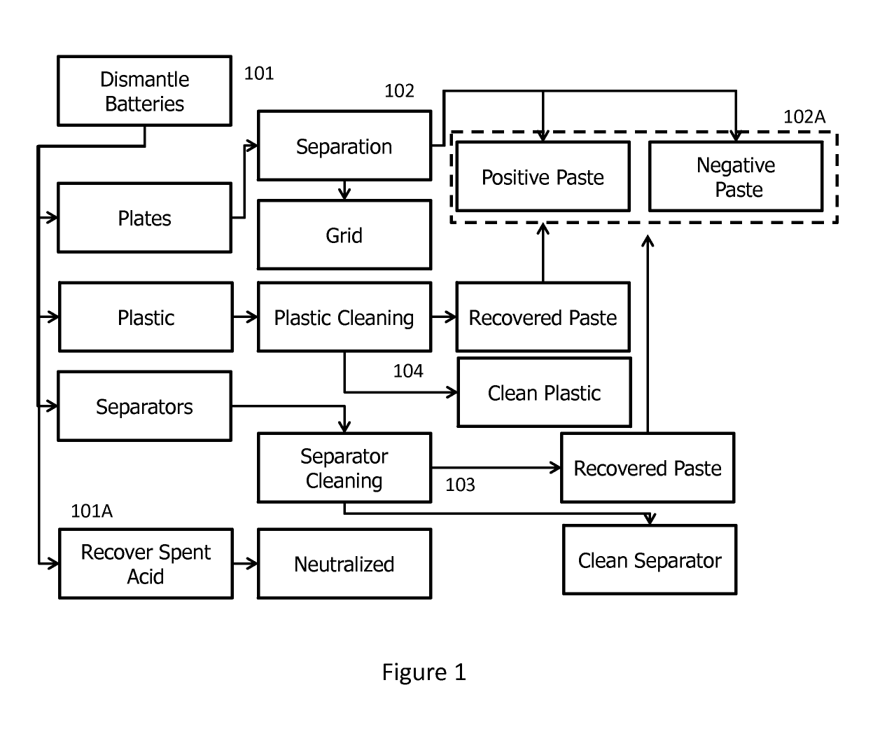

FIG. 1 depicts a schematic of a process for recovering lead from used lead acid batteries, in accordance with an embodiment of the present disclosure. In an embodiment, the process may include, at operation 101, dismantling the batteries. The VRLA and flooded batteries may be segregated and dismantled separately. A dismantled battery may have parts such as, for example, plates, separators (e.g., AGM separator), and plastic parts (e.g., container). Dismantling the batteries may further include, at operation 101A, recovering the spent sulfuric acid after dismantling the batteries. In case of flooded batteries, the sulfuric acid is drained from the batteries and collected in an acid collection tank. In case of VRLA batteries, the sulfuric acid is trapped inside the AGM separators. The acid is recovered after passing the AGM separators through a hydraulic press.

The process further includes, at operation 102, separating the metallic or metal containing components (in the form of lead metal, lead oxides, lead sulfate and non-lead metallic impurities) and non-metallic components (example battery containers and separators). At operation 102A, the metallic components may be classified for positive and negative plates. They then can be treated separately or together as described in detail later.

The process further includes, at operation 103, cleaning the separators and, at operation 104, cleaning the plastics.

The process described focuses on desulfurizing the lead sulfate, oxidizing the stuck lead metal, reducing the stuck lead dioxide to lead monoxide, and then dissolving the lead monoxide and the free metal in an acidic solution to clean the non-metallic components. Lead is then recovered from the acidic solution. Below are described in detail the process steps for each non-metallic component.

Separators: Typically Absorbed Glass Mat (AGM) and Poly-ethylene (PE) separators are used in lead acid batteries. AGM separators are used in VRLA and PE separators are used in flooded lead-acid batteries respectively. After dismantling the batteries, the dirty separators typically contain lead and lead compounds (oxides and sulfates). The total lead content in the separators may be up-to 40% of the total separator weight (up-to 5% of the total lead content in the used battery). To clean the separators and recover the stuck lead and lead compounds, they can be treated via two different processes.

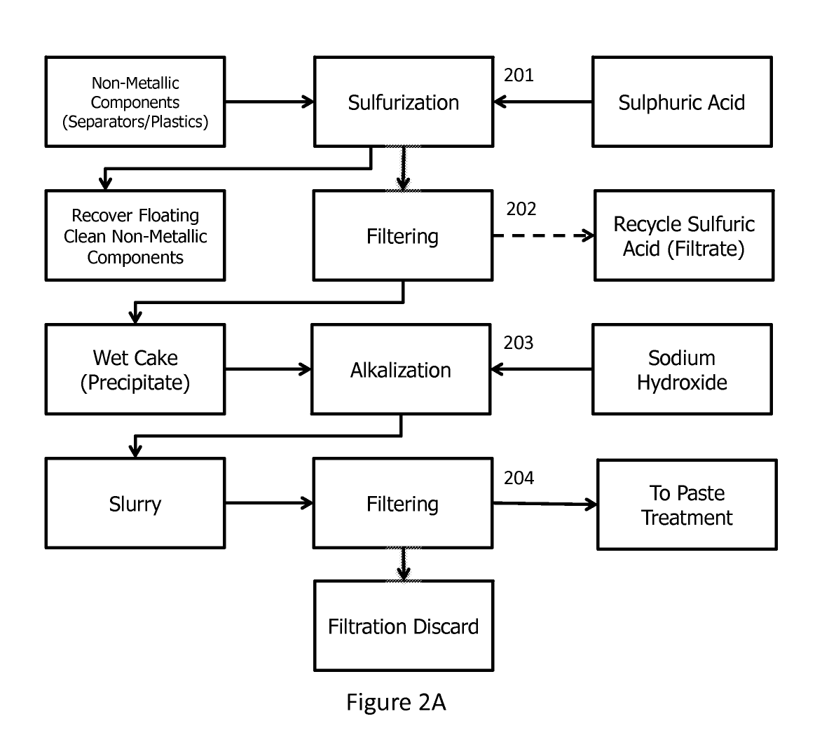

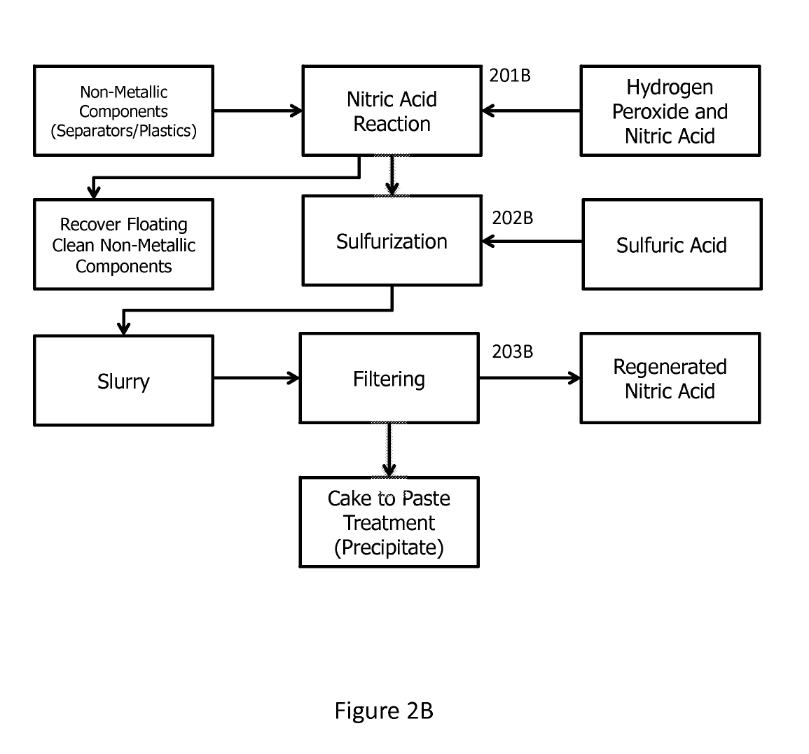

FIG. 2A depicts a schematic of a process for recovering the lead and lead compounds stuck on the non-metallic components recovered at operation 102, in accordance with an embodiment disclosed herein. In an embodiment, the process for cleaning separators may include sulfuric acid and acetic acid treatment.

At operation 201, the dirty separators are agitated in a reaction tank with 60-80% solution of sulfuric acid (H₂SO₄) at 65-85° C. for 15-30 minutes, in a separator to solution weight ratio of 1:2-3. The desired agitation speed is between 200-500 revolutions per minute (rpm). The following reactions take place where all lead components are converted to lead sulfate with the evolution of oxygen. The separators are thus cleaned from all stuck lead. The cleaned up separators then float on the top of the solution and can be recovered.

Pb+PbO₂+2H₂SO₄=2PbSO₄+2H₂O

2PbO₂+2H₂SO₄=2PbSO₄+2H₂O+O₂

PbO+H₂SO₄=PbSO₄+H₂O

The recovered cleaned separators are washed with demineralized water (DM) in a weight ratio of 1:2-3. The washed separators are then sent to their respective recycling units.

The composition obtained after recovering the cleaned up separators is then filtered, at operation 202, to obtain the unused sulfuric acid as the filtrate and lead sulfate as the precipitate. In some embodiments, the unused sulfuric acid may be reused in subsequent cleanings.

At operation 203, the precipitate is treated with an alkali in stoichiometric quantity. In an embodiment, hydroxides and carbonates of sodium and potassium may be used to desulfurize the precipitate as per the following reaction(s)

2NaOH+PbSO₄=Na₂SO₄+PbO+H₂O

2KOH+PbSO₄=K₂SO₄+PbO+H₂O

Na₂CO₃+PbSO₄=Na₂SO₄+PbCO₃

K₂CO₃+PbSO₄=K₂SO₄+PbCO₃

PbCO₃+Heating=PbO+CO₂.

The alkali concentration may be kept between 20-60% and the reaction temperature may be kept between 40-95° C. The reaction is done for 30-60 minutes. The solid to liquid weight ratio is kept between 1:2-3. For the alkali hydroxides, the lead hydroxides formed breaks into lead monoxide (which precipitates out) and water. For sodium (and potassium) carbonate, lead carbonate (which precipitates out) is formed which can be heated at 250-400° C. to obtain lead monoxide and carbon dioxide. In an embodiment, evolved carbon dioxide can be trapped for further use. The resulting product is filtered at operation 205. The filtrate is sodium (or potassium) sulfate solution regardless of whether a hydroxide or a carbonate is used for the alkali treatment. The lead monoxide obtained is added to the paste treatment stream as described in detail later.

FIG. 2B depicts a schematic of an alternate process for recovering the lead and lead compounds stuck on the non-metallic components recovered at operation 102, in accordance with an embodiment disclosed herein. In an embodiment, the process for cleaning separators may include hydrogen peroxide and nitric acid treatment.

A solution of 10-40% hydrogen peroxide (H₂O₂) and 10-40% nitric acid (HNO₃) is prepared. At operation 201B, the dirty separators are agitated in a reaction tank containing the hydrogen peroxide and nitric acid solution and agitated for 15-30 minutes at 20-50° C. The separator to solution weight ratio is kept at 1:2-3. The desired agitation speed is 200-500 rpm. The following reactions take place and after that the clean separators float on top of the solution and can be recovered.

PbO₂+H₂O₂=PbO+H₂O+O₂

Pb+H₂O₂=PbO+H₂O

PbO+2HNO₃=Pb(NO₃)₂+H₂O

The recovered cleaned separators are washed with DM water in a weight ratio of 1:2-3. The washed separators are then sent to their respective recycling units and the wash water. Sulfuric acid of 15-40% concentration is added, at operation 202B, to the reaction tank after recovering the separators. The lead nitrate (Pb(NO₃)₂) converts to lead sulfate which precipitates out per the following reaction. In an embodiment, nitric acid is regenerated and can be reused in subsequent processing.

Pb(NO₃)₂+H₂SO₄=PbSO₄+2HNO₃

The composition obtained following sulfuric acid treatment is filtered, at operation 203B, to obtain lead sulfate as the precipitate and regenerated nitric acid as the filtrate. The lead sulfate thus obtained may be further processed as described in detail later.

Plastic container and plastic top lid: The lead-acid battery cells are enclosed in a plastic container and then sealed with a plastic lid. When the used batteries are dismantled, lead and lead compounds (oxides and sulfates) are stuck on the plastics. Simple operations like agitating with DM water or pressure washing with DM water are not sufficient to remove and recover the stuck lead and lead compounds. The total lead content stuck with the plastics is up-to 25% (up-to 5% of the total lead content in the battery).

In an embodiment, a process to recover the lead and lead compounds and clean the plastics before being sent for plastics recycling may include sulfuric acid and acetic acid treatment: The dirty plastics (container and top lid) are first ground into smaller pieces e.g., by using a grinding machine. The small plastic pieces are agitated in a reaction tank with 60-80% solution of sulfuric acid (H₂SO₄) at 65-85° C. for 15-30 minutes, in a separator to solution weight ratio of 1:2-4. In an embodiment, the agitation speed may be between 200-500 revolutions per minute (rpm). The following reactions take place where all lead components are converted to lead sulfate with the evolution of oxygen. The separators are thus cleaned from all stuck lead. The cleaned up separators then float on the top of the solution and can be recovered.

Pb+PbO₂+2H₂SO₄=2PbSO₄+2H₂O

2PbO₂+2H₂SO₄=2PbSO₄+2H₂O+O₂

PbO+H₂SO₄=PbSO₄+H₂O

The recovered cleaned plastics are then washed with DM water in a weight ratio of 1:2-4. The washed plastics may then be recycled. The composition obtained after recovering the cleaned up plastics is then filtered to obtain the unused sulfuric acid as the filtrate and lead sulfate as the precipitate. The unused sulfuric acid can be reused in subsequent cleanings. The precipitate is treated with alkali as described above to desulfurize. The lead monoxide obtained is added to the paste treatment stream as described in detail later.

In an embodiment, the process to recover the lead and lead compounds and clean the plastics before being sent for plastics recycling may include hydrogen peroxide and nitric acid treatment: Hydrogen peroxide and nitric acid treatment: A solution of 10-40% hydrogen peroxide (H₂O₂) and 10-40% nitric acid (HNO₃) is prepared.

The dirty plastics (container and top lid) are first grinded into smaller pieces by using a grinding machine. The smaller plastic pieces are then agitated in a reaction tank containing the hydrogen peroxide and nitric acid solution and agitated for 15-30 minutes at 20-50° C. The plastic to solution weight ratio is kept at 1:2-4. The desired agitation speed is 200-500 rpm. The following reactions take place and after that the clean plastics float on top of the solution and can be recovered.

PbO₂+H₂O₂=PbO+H₂O+O₂

Pb+H₂O₂=PbO+H₂O

PbO+2HNO₃=Pb(NO₃)₂+H₂O

The recovered clean plastics are washed with DM in a weight ratio of 1:2-4. The washed plastic may be then recycled. Sulfuric acid of 15-40% concentration is added to the reaction tank after recovering the clean plastics. The lead nitrate (Pb(NO₃)₂) converts to lead sulfate which precipitates out per the following reaction. Nitric acid is regenerated and can be reused in subsequent processing.

Pb(NO₃)₂+H₂SO₄=PbSO₄+2HNO₃

The composition above is filtered to obtain lead sulfate as the precipitate and regenerated nitric acid as the filtrate. The lead sulfate obtained is sent to the paste treatment as described later.

The metallic components obtained at operation 102 are separated into metal and paste (mixture of lead oxides and lead sulfate) by the following process. It should be noted that the metal components obtained at operation 102 could, in an embodiment, be classified at operation 102A into a “positive plate” and a “negative plate” stream by processing the positive and negative plates of the spent batteries separately. Alternatively, both the negative and positive plates can be processed together as well to obtain the “mix stream”.

The metallic components obtained are wet-grinded in a grinding machine. The composition obtained from wet grinding may then be wet classified with a sieve of mesh size 100-400 (149-37 microns). The coarser composition, which is retained by the sieve, is the grid metal (the alloy used in battery manufacturing). In an embodiment, the grid metal may be further processed for additional lead recovery.

The finer composition, which passes through the sieve, is the paste. This paste is a mixture of lead compounds (lead monoxide, lead dioxide, free lead (the active lead material which comes from the “grey oxide” used in the battery plates manufacturing and some very fine grid metal pieces which escape the wet classification) and lead sulfate) and other non-lead metallic impurities. The details of processing the paste are provided later herein.

The metal obtained from the coarser composition may, in some instances, also have some paste stuck to it, which reduces the metal recovery if not treated before sending it to the refining chamber. It is treated as follows to increase the metal recovery.

Pure sodium hydroxide flakes are melted in a standard refining kettle at 300° -450° C. for 20-50 minutes. The amount of sodium hydroxide is 5-30% by weight of the metal being treated. The grid metal is charged into the chamber once the sodium hydroxide melts. The lead sulfate in the stuck paste is converted into lead monoxide. The original oxides (both lead monoxide and lead dioxide) and the lead monoxide formed after desulfurization of the lead sulfate form dross with the sodium hydroxide.

The lead oxides and sodium hydroxide dross can be recovered using standard dross tapping techniques. The cleaned metal (lead alloy) can be removed from the refining chamber using standard methods. The removed metal can be refined or alloyed to desired purity levels using standard techniques. It should be noted that the refining or the alloying operations can be done in the same chamber (in which the sodium hydroxide treatment is done) or can be done in a separate chamber.

The dross may be dissolved in water in a weight ratio of 2:4-5 to obtain sodium hydroxide in solution and the lead oxides (lead monoxide and lead dioxide) as a precipitate. The composition is filtered to obtain sodium hydroxide solution as the filtrate which may be recycled for appropriate process. The precipitate is a mixture of lead oxides, which is processed further as described in detail later.

The paste obtained following the processing of non-metallic and metallic/metal containing components is composed mostly of lead oxides (lead monoxide, lead dioxide), lead sulfate and non-lead metallic impurities. Below are described various processes to obtain very high purity lead oxides from paste obtained from spent lead acid batteries.

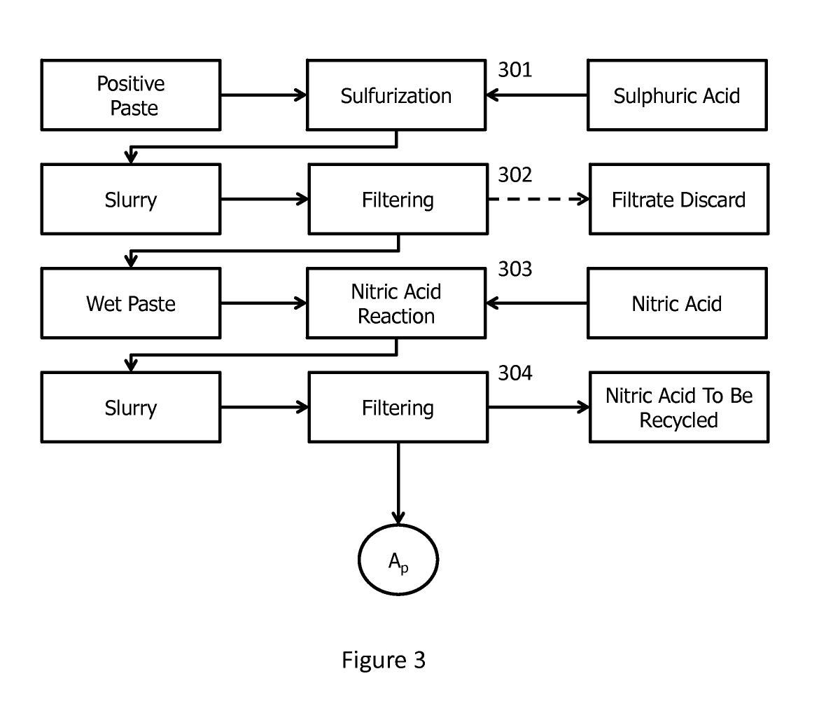

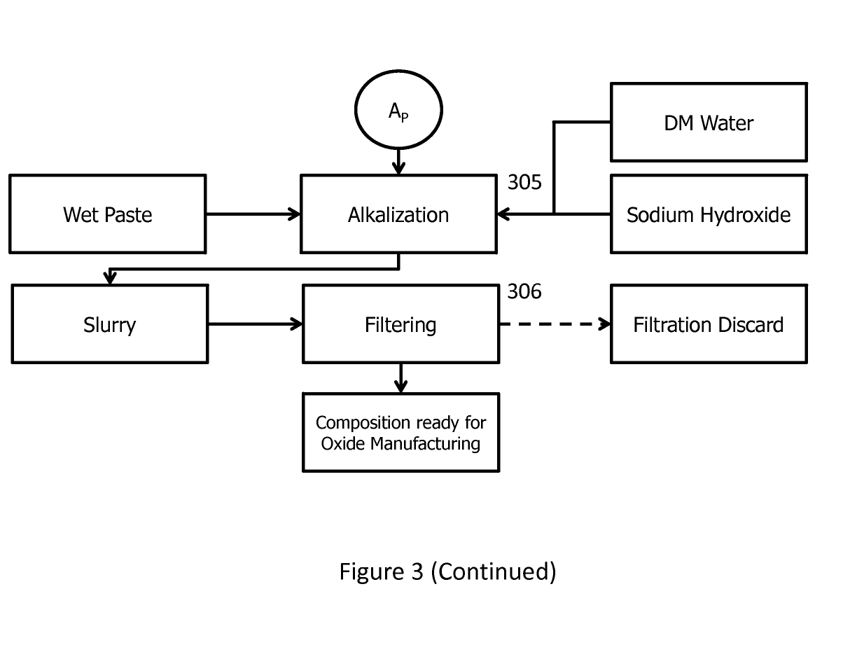

FIG. 3 depicts a schematic of a process for producing lead oxide from paste obtained from positive plates in accordance with an embodiment of the present disclosure. The paste obtained from the positive plates typically consists of lead dioxide (40-70%), lead sulfate (20-50%), lead monoxide (up-to 15%), free lead (up-to 5%) and non-lead metallic impurities (up-to 1%). A detailed composition analysis of the paste is done before starting the treatment process.

In an embodiment, the process may include, at operation 301, treating the paste with sulfuric acid: Treat the paste with 15-30% sulfuric acid (e.g., the spent acid obtained from the used batteries) in a reaction vessel to convert the free lead and PbO into lead sulfate in the presence of lead dioxide as per the following reaction. The paste to sulfuric acid solution weight ratio is taken to be 1:1-3 and the slurry is agitated at 100-250 rpm for 40-80 minutes. Since the PbO₂ is in excess, only the required amount (per the reaction stoichiometry) is used during the oxidation of Pb and the remainder PbO₂ continues to be in the paste unreacted.

Pb+PbO₂+2H₂SO₄=2PbSO₄+2H₂O

PbO+H₂SO₄=PbSO₄+H₂O

At operation 302, the obtained composition is filtered to obtain the unused sulfuric acid as the filtrate and a mixture of lead sulfate, lead dioxide and non-lead metallic impurities as precipitate. The filtrate can be reused in appropriate process steps.

At operation 303, the precipitate is then treated with 10%-40% nitric acid in a weight ratio of 1:1-3 at 40-80° C. Nitric acid dissolves the non-lead metallic impurities as soluble nitrates. The lead sulfate and lead dioxide remain in the precipitate state.

At operation 304, the composition is filtered then to obtain lead sulfate and lead dioxide as precipitate and unused nitric acid and non-lead metallic impurities nitrates as the filtrate. This nitric acid can be reused in appropriate process steps and is monitored for the concentration of various non-lead metallic impurities. This is monitored by tracking the respective solubility of various nitrates in nitric acid. Once a critical level is reached, the various nitrates may be precipitated out as hydroxides by treatment with sodium hydroxide.

A component analysis of the precipitate is done to find out the amount of lead sulfate and lead dioxide. At operation 305, a paste of the precipitate and DM water in a weight ratio of 1:2-3 is prepared. Stoichiometric amount of an alkali (hydroxides and carbonates of sodium and potassium), e.g., sodium hydroxide, is then added to the paste. The desired temperature range for the desulfurization reaction is between 40-95° C. This addition of the sodium hydroxide is exothermic (heat of mixing is generated) which helps in heating the reaction mixture. In an instance of the process, a temperature rise of 80-100° C. per kilogram of sodium hydroxide added to one kilogram of water has been observed. One of skill in the art will readily appreciate that this sequence of addition of reactants to the process reduces (or may even eliminate) the amount of heating required for effective reaction. It is to be noted that the degree of desulfurization can be controlled by the amount of alkali used in a single step or in multiple steps in sequence. Each treatment stage can be optimized to control the amount of de-sulfurization by controlling the reaction time, reaction temperature and concentration of the alkali solution. With this multi-stage alkali treatment process, de-sulfurizaton in the range of 85%-99.99% may be achieved. This may be used in preparing a “pre-sulfated” oxide as described in detail later.

PbSO₄+2NaOH=PbO+Na₂SO₄+2H₂O

At operation 306 the slurry obtained after the desulfurization reaction in is filtered to obtain sodium sulfate in filtrate and a mixture of lead monoxide and lead dioxide in the precipitate. The precipitate obtained is washed thoroughly to remove any residual sodium to obtain very pure mixture of PbO and PbO₂ This mixture can be treated to obtain pure usable oxides as described in detail later.

In an alternate embodiment, the process producing lead oxide from paste obtained from positive plates may include treatment using nitric acid (not shown). The paste is treated with 10%-40% nitric acid in a weight ratio of 1:2-3 at 40-80° C. in a reaction chamber. The slurry is agitated at 100-250 rpm for 30-60 minutes. The free lead, PbO and the non-lead metallic impurities form soluble nitrates and come in the solution. Lead dioxide and lead sulfate remain as precipitate and can be filtered. Nitrous oxide (NO) is evolved, which, in an embodiment may be trapped.

3Pb+8HNO₃=3Pb(NO₃)₂+4H₂O+2NO

PbO+2HNO₃=Pb(NO₃)₂+H₂O

The composition is then filtered to obtain unused nitric acid and metallic nitrates (both lead and non-lead) as the filtrate and lead sulfate and lead dioxide as precipitate. The filtrate is treated with concentrated sulfuric acid to convert lead nitrate to lead sulfate, which precipitates, and to regenerate the nitric acid, which can be reused in appropriate process steps. The monitoring of nitric acid may be done as described earlier.

The composition obtained is then filtered to obtain lead sulfate as a precipitate. The obtained lead sulfate is added to the further treatment process described later.

The precipitate obtained following nitric acid treatment and the lead sulfate obtained in following sulfuric acid treatment are then treated with sodium hydroxide as described above (in the process described with reference to FIG. 3).

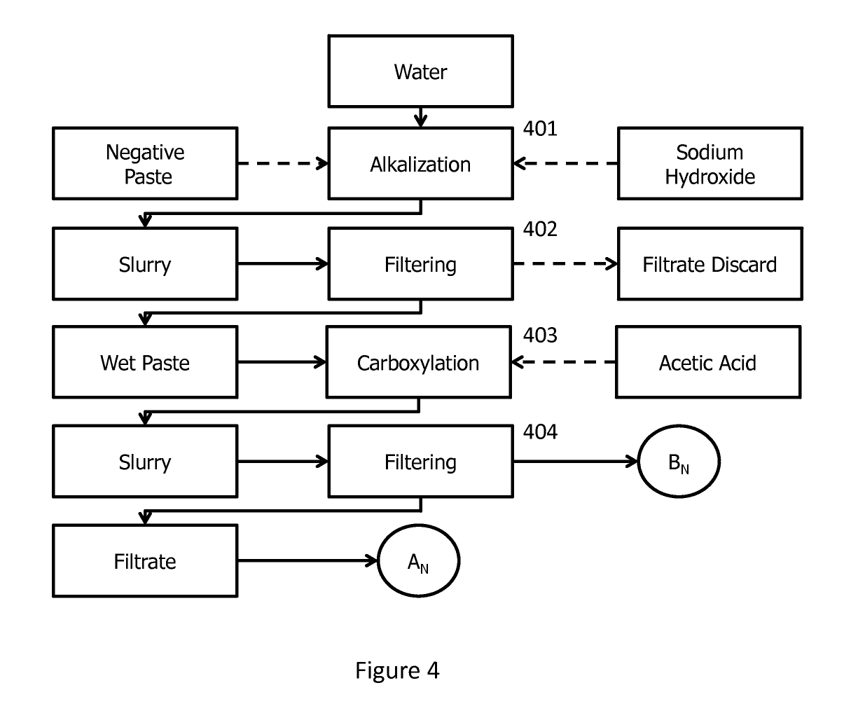

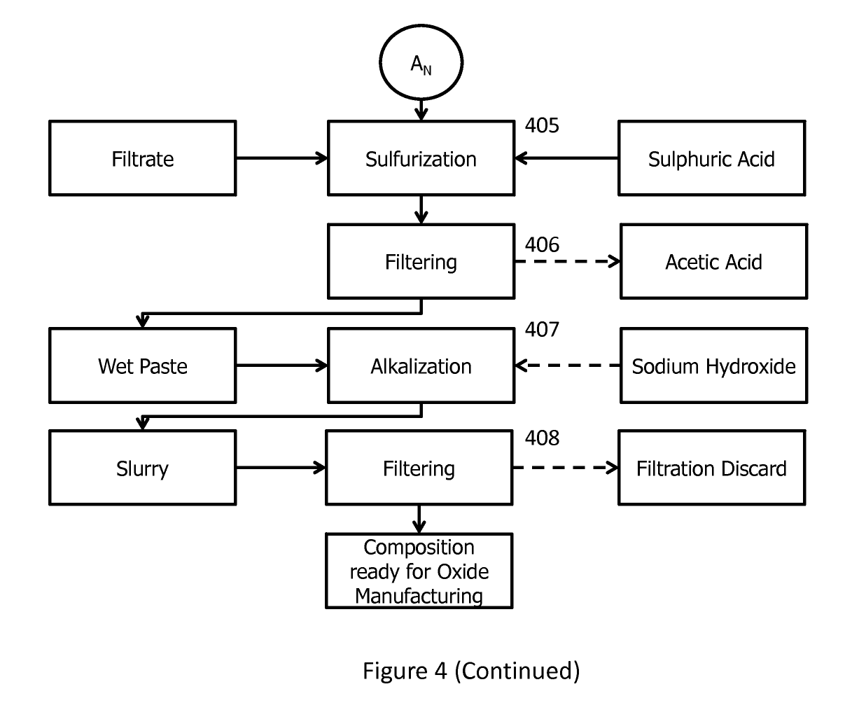

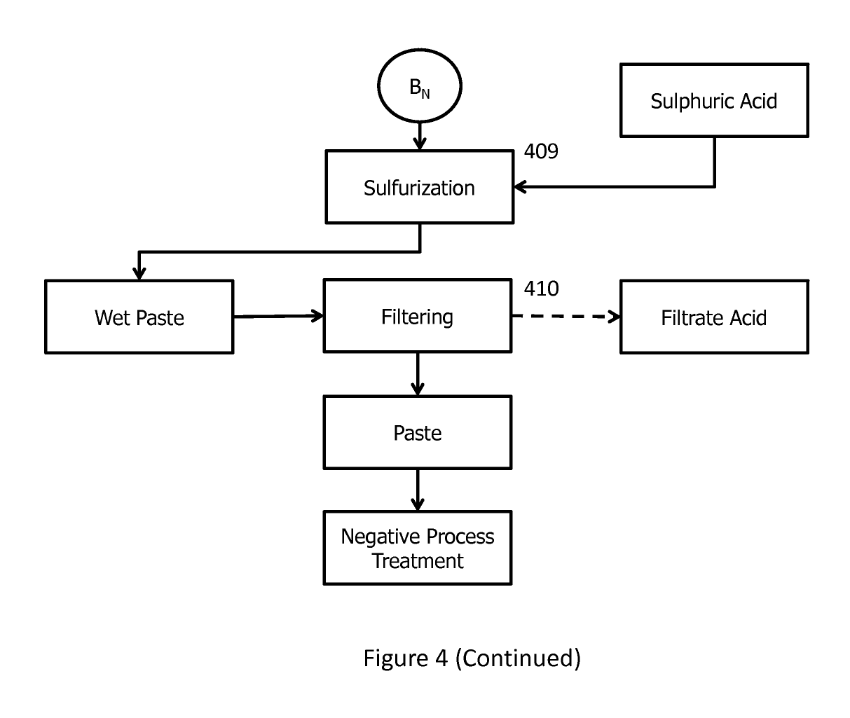

FIG. 4 depicts a schematic of a process for producing lead oxide from paste obtained from negative plates from spent lead-acid batteries, according to an embodiment of the present disclosure. The paste obtained from the negative plates typically consists of lead sulfate (30-70%), lead monoxide (30-70%), free lead (up-to 15%) and non-lead metallic impurities (up-to 5%). A detailed composition analysis of the paste is done before starting the treatment process.

In an embodiment, the process may include, at operation 401, preparing a slurry of paste and DM water where the weight of paste and DM water is kept between 1:1-3. To this slurry, a stoichiometric amount of sodium hydroxide is added. This composition is agitated at 100-250 rpm for 30-60 minutes to convert the lead sulfate to lead monoxide. The free lead and non-lead metallic impurities remain as such and form a precipitate with the lead monoxide.

At operation 402, the composition obtained is filtered to obtain the filtrate (sodium sulfate) and precipitate (lead monoxide, non-lead metallic impurities and free lead).

At operation 403, the precipitate is added to a 10-50% acetic acid (CH₃COOH) solution in a weight ratio of 1:1-3 with the total acetic acid being kept in excess. The amount of PbO in the precipitate dictates the concentration of the acetic acid being utilized in the reaction. This resulting slurry is agitated in a reactor at 100-250 rpm for 30-60 minutes. The temperature of the composition may, in an embodiment, be maintained between 45-90° C. The acetic acid leaches PbO forming lead acetate (Pb(CH₃COO)₂) and generates a heat of reaction, providing a temperature rise of about 20-25° C. for 1 kg PbO and stoichiometric amount of acetic acid in 1:2 weight ratio of solid to liquid phase. Advantageously, this temperature rise reduces the amount of heating required for an effective reaction.

PbO+2CH₃COOH=Pb(CH₃COO)₂+H₂O

At operation 404, the composition obtained following operation 403 is filtered to obtain lead acetate as the filtrate and the free lead and other impurities as a precipitate.

At operation 405, the lead acetate filtrate is treated with concentrated sulfuric acid to form lead sulfate. This composition is filtered, at operation 406, to obtain lead sulfate as a precipitate and regenerated acetic acid as the filtrate. This acetic acid is recycled for use in subsequent batches.

Pb(CH₃COO)₂+H₂SO₄=PbSO₄+2CH₃COOH

At operation 407, the precipitate obtained following operation 406 is treated with sodium hydroxide as described with respect to the process depicted in FIG. 3. This composition is filtered, at operation 408, to obtain pure lead monoxide as the precipitate and sodium sulfate as the filtrate. The lead monoxide precipitate obtained is washed thoroughly with DM water to remove any residual sodium to obtain very pure PbO which can be treated to obtain very pure usable oxides as described in detail later.

At operation 409, the precipitate obtained following operation 404 is treated with positive stream paste (e.g., process described with reference to FIG. 3) to facilitate the oxidation of free lead as described earlier with reference to FIG. 3. This composition will now contain lead sulfate and sulfates of other non-lead metals (majority of barium sulfate, an additive used in the battery manufacturing). This sulfate composition obtained is treated with sodium hydroxide as per the process step described above to convert lead sulfate to lead monoxide. The sodium sulfate comes into the solution and the lead monoxide and non-lead metallic sulfates remain in the precipitate.

The composition is filtered to obtain the sodium sulfate filtrate, which is sent to the effluent treatment step. Operations 403-407 may then be repeated to treat the precipitate.

The precipitate obtained after the leaching with acetic acid now contains the non-lead metallic impurities, which have been effectively removed from the system and can be converted to marketable forms.

In an embodiment (not shown), the lead acetate obtained following operation 403 is treated with carbon dioxide (CO₂) to form lead carbonate (PbCO₃) and regenerate acetic acid. Lead carbonate then can be heated to obtain lead monoxide and carbon dioxide (which can be recycled back in the system).

Pb(CH₃COO)₂+CO₂+H₂O=PbCO₃+2CH₃COOH

In an embodiment, the positive and negative paste streams can be mixed (mix paste stream) and treated together to obtain pure lead oxides. Prior to the treatment, a detailed composition analysis of the paste is done. In an embodiment, the process may include treatment with no reduction of lead dioxide coming from positive stream:

The mix stream paste is treated as per operations 301-303. At the end of these steps, a cake of lead dioxide and lead sulfate is obtained. This cake may still contain barium as an impurity and may require further treatment to remove barium.

The cake is agitated with concentrated sulfuric acid of concentration greater than 90% at 30°-50° C. to dissolve barium. In an embodiment, this agitation is done for 40-80 minutes at 100-250 rpm. The cake to acid solution weight ratio is taken to be 1:1-3. It should be noted that at between 70°-100° C., the lead dioxide will be reduced to PbO and thus the temperature control may be required.

The composition obtained is filtered to obtain pure lead sulfate and lead dioxide. The filtrate is concentrated sulfuric acid, which can be reused by monitoring the barium concentration. Once a critical level of barium sulfate reaches in the sulfuric acid solution, the acid can be diluted to obtain a pure barium sulfate precipitate, which may, advantageously, be sold in the market.

The precipitate is treated as per the steps in operations 405-408 to obtain pure lead oxide.

In an embodiment, the process for treatment of positive and negative streams to obtain lead oxides may include treatment with reduction of lead dioxide coming from positive stream: High purity oxides can be directly extracted from the paste obtained from positive and negative plates by first reducing the lead dioxide and then treating the resulting composition to obtain very pure PbO.

The mix paste stream is agitated with a solution of 50-80% sulfuric acid at 70°-100° C. for 40-80 minutes at 100-250 rpm. This reduces the lead dioxide to lead monoxide and converts all lead monoxide (the initial PbO coming in from the mix paste stream and the one obtained by reduction of PbO₂). In addition, the free lead is also oxidized in the presence of lead dioxide and sulfuric acid. The composition obtained is filtered to obtain lead sulfate, and non-lead metallic impurities. The sulfuric acid is obtained as a filtrate, which can be reused in subsequent batches. A detailed composition analysis of the precipitate is done and then it is treated, as has been described elsewhere herein, to obtain very pure PbO.

2PbO₂+2H₂SO₄=2PbSO₄+2H₂O+O₂

Alternatively, the PbO₂ can also be reduced by treating it with a mixture of hydrochloric acid (HCl) and sulfuric acid. An acidic medium is prepared by mixing sulfuric acid of 30-50% concentration and hydrochloric acid of 30-50% concentration. The primary role of hydrochloric acid is to reduce the lead dioxide to lead monoxide. Evolved chlorine gas and stored in storage tanks. Sulfuric acid is kept in excess while the hydrochloric acid is added in stoichiometric amount depending on amount of lead dioxide to be reduced to lead monoxide. The excess sulfuric acid converts the initial lead monoxide to lead sulfate. The free lead present in the mix paste stream is also oxidized in the presence of lead dioxide and sulfuric acid.

PbO₂+2HCl+H₂SO₄=PbSO₄+Cl₂+2H₂O

The mix stream paste is agitated with the acidic medium prepared at 55-90° C. for 40-80 minutes at 100-250 rpm. The composition is filtered to obtain lead sulfate and non-lead metallic impurities as a precipitate and the acidic medium as the filtrate, which can be reused.

A detailed composition analysis of the precipitate is done and it undergoes further treatment as per operations 401-409 to obtain very pure PbO.

The treated paste will be either (a) pure lead monoxide or (b) a mixture of pure lead monoxide and lead dioxide. These can be converted to usable oxides as follows.

Litharge can be prepared by following methods:

Pure lead monoxide can be baked in an oven at 100°-150° C. for 1-2 hours to obtain high purity (99.99+%) litharge. The mixture of lead monoxide and lead dioxide can be heated at 500°-550° C. for 1-2 hours to reduce lead dioxide to lead monoxide and to obtain high purity (99.99+%) litharge.

Alternatively, pure lead monoxide can be extracted from the mixture of lead monoxide and lead dioxide with acetic acid (treatment with acetic acid, followed by precipitation with sulfuric acid and then finally desulfurization with sodium hydroxide) and baked in an oven at 100°-150° C. for 1-2 hours to obtain high purity (99.99+%) litharge.

Red lead (Pb₃O₄) with controlled percentage of lead dioxide (PbO₂): The percentage of lead dioxide (PbO₂) in the product can be 15-60%. Typical ranges of lead dioxide percentages required in various grades of red lead are 15.1-25.1%, 25.2-33.2%, 33.3%+. To accurately control the percentage of PbO₂ we will have to either increase or decrease its percentage in the product.

To decrease the percentage of PbO₂, the product is heated at 500°-550° C. to reduce the PbO₂ to PbO and obtain very pure (99.99%) red lead of desired PbO₂ percentage. The heating time duration is optimized on the percentage of PbO₂ required in the final red lead.

To increase the percentage of PbO₂, the product is leached with stoichiometric quantity of acetic acid (to leach out PbO) required to have the desired percentage of PbO₂.

The product is treated with the desired amount of acetic acid to form lead acetate in the solution from the desired PbO amount reduction. The composition is then filtered to obtain lead acetate as the filtrate and the mixture of lead dioxide and un-reacted lead monoxide as the precipitate. The lead acetate filtrate can be further processed as has been described.

Heating the precipitate obtained at 450°-550° C. to obtain pure red lead of desired PbO₂ percentage.

Pre-sulfated lead oxide (a.Pb.xPbO.yPbO₂.zPbSO₄) with specified percentages of free lead (Pb), lead monoxide (PbO), lead dioxide (PbO₂,) and lead sulfate (Pb SO₄). The degree of de-sulfurization is controlled to the desired percentage of lead sulfate required.

It is advantageous that the acidic medium used in step 303 can be prepared from the dilute nitric acid obtained from step 304. In an embodiment, the acetic acid used in leaching of lead monoxide using standard cation exchange membrane may be regenerated.

In an embodiment, carbon dioxide is produced after the heating lead carbonate. This carbon dioxide can be used again in carbonating lead acetate obtained.

One aspect of the present disclosure is directed to a plant for recovering lead oxide from used lead-acid batteries. In an embodiment, a plant for recovering lead oxide from non-metallic components of used lead-acid batteries may include a crusher configured to crush the non-metallic components of the used lead-acid batteries, the non-metallic components comprising plastics, separators, and residual lead compounds and alloys; and a first reactor having a reduction chamber for contacting crushed non-metallic components with a reducing mixture comprising a nitric acid solution to reduce at least a portion of residual lead compounds and alloys, wherein lead in the portion of residual lead compounds and alloys is reduced from an insoluble +4 state to a soluble +2 state to form a slurry with a lead-rich filtrate. The plant may further include a filtration system for filtering the slurry to separate plastics and separators from the lead-rich filtrate, and a second reactor having a sulfatation chamber for contacting the lead-rich filtrate with sulfuric acid to obtain a lead sulfate paste and nitric acid. The plant may further include a third reactor having a processing the lead sulfate paste to obtain lead oxide.

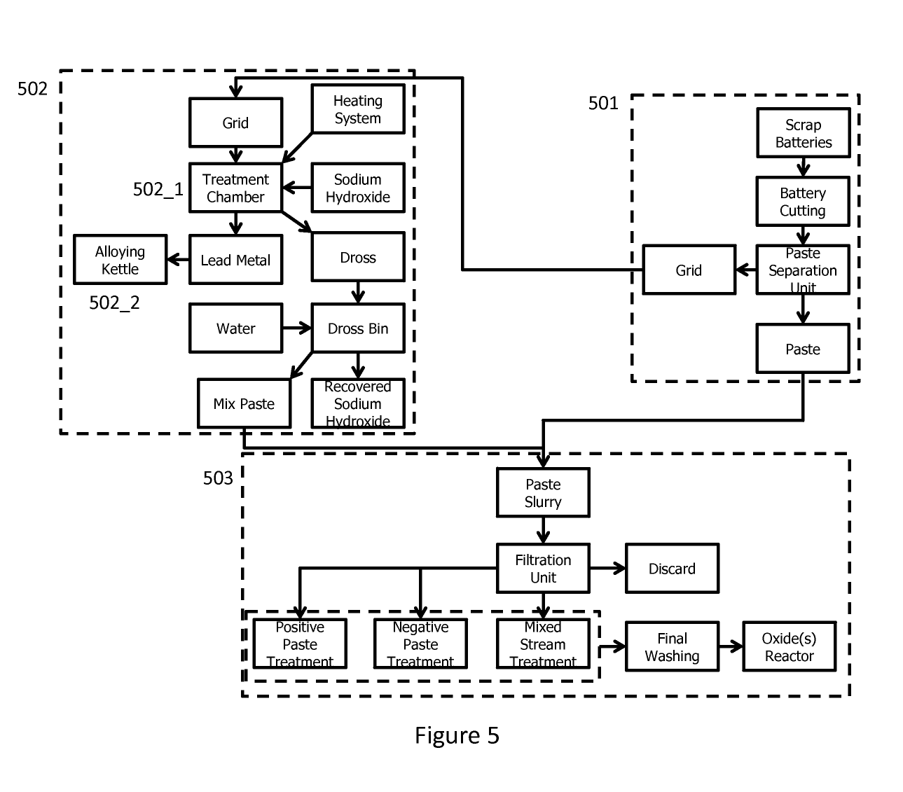

FIG. 5 depicts a schematic of a plant for producing lead oxide from spent lead-acid batteries, according to an embodiment of the present disclosure. The unit 501 describes the battery dismantling and paste separation unit. Here, first the spent batteries are either cut and/or crushed to separate out the metallic and non-metallic components. Then, the metallic components are sent to a paste separation unit where the grid metal and paste undergo a wet classification process. The paste can be positive, negative or mix stream as described earlier. The paste separation unit can be a part of the battery dismantling unit or a separate unit as shown in FIG. 5. It should also be pointed out that the paste obtained from the paste separation unit can be of desired fineness as described earlier.

The unit 502 describes the grid treatment unit. It consists of a treatment kettle (502_1), ideally made of stainless steel of a suitable grade, which can handle molten sodium hydroxide, in which the grid treatment is done as described earlier. The unit 502 also describes an alloying (or refining) unit (5022), which can be used for manufacturing of lead alloys. It should be noted that the alloying or refining operations could also be completed in the treatment kettle.

The unit 503 describes the paste treatment unit as per the process steps described earlier. It can consist of appropriate filtration units, example filter press and centrifuge. The filtration units should be manufactured with appropriate materials, which can handle the various acidic and basic conditions encountered in the recycling process. Further, it should be understood that there could be one or multiple filtration units depending on recycling capacity and process schedule.

The unit 503 also consists of various reaction chambers (reactors), which facilitate the chemical reactions. It should be understood that these reaction chambers would have appropriate agitation and heating (cooling) facilities to enhance the various reaction kinetics. The reaction chambers should be manufactured with appropriate materials, which can handle the various acidic and basic conditions encountered during the recycling process. Further, it should be clear to those skilled in the art that there can be one or multiple reaction chambers which facilitate one or more process reactions.

In an embodiment, a plant for recovering lead oxide from metallic components of used lead acid batteries may include a first reactor for processing the metal containing components to form a paste comprising sulfates of lead and other metals present in the metal containing components, a second reactor having a hydroxylation chamber for contacting the paste comprising sulfates of lead and other metals with alkali to form a precipitate comprising oxides of lead, and a third reactor having a carboxylation chamber for contacting the precipitate comprising oxides of lead with a carboxylic acid to form soluble lead carboxylates. The plant may further include a fourth reactor for processing soluble lead carboxylates to obtain lead monoxide.

In another embodiment, a plant for recovering lead oxide from used lead acid batteries may include a crusher configured to crush non-metallic components of the used lead-acid batteries, the non-metallic components comprising plastics, separators, and residual lead compounds and alloys, and a first reactor having a reduction chamber for contacting crushed non-metallic components with a reducing mixture comprising a nitric acid solution to reduce at least a portion of residual lead compounds and alloys, wherein lead in the portion of residual lead compounds and alloys is reduced from an insoluble +4 state to a soluble +2 state to form a slurry with a lead-rich filtrate. The plant may also include a first filtration system for filtering the slurry to separate plastics and separators from the lead-rich filtrate, and a second reactor having a sulfatation chamber for contacting the lead-rich filtrate and precipitates containing compounds of lead and other metals with sulfuric acid to obtain a paste comprising sulfates of lead and other metals. The plant may further include a second filtration system for separating the paste comprising sulfates of lead and other metals from a suspension, a third reactor having a hydroxylation chamber for contacting the paste comprising sulfates of lead and other metals with alkali to form a precipitate comprising oxides of lead, and a fourth reactor having a carboxylation chamber for contacting the precipitate comprising oxides of lead with a carboxylic acid to form soluble lead carboxylates. The plant may additionally include a fifth reactor for processing soluble lead carboxylates to obtain lead monoxide. In some embodiments acid generated following sulfatation in the second reactor is recycled and reused in the plant. In some embodiments, acid generated following processing soluble lead carboxylates in the fifth reactor is recycled and reused in the plant. In some embodiments, carbon dioxide generated following processing soluble lead carboxylates in the fifth reactor is recycled and reused in the plant.

The foregoing detailed description has set forth various embodiments of the devices and/or processes by the use of diagrams, flowcharts, and/or examples. Insofar as such diagrams, flowcharts, and/or examples contain one or more functions and/or operations, it will be understood by those within the art that each function and/or operation within such diagrams, flowcharts, or examples can be implemented, individually and/or collectively, by a wide range of hardware, software, firmware, or virtually any combination thereof

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

All references, including but not limited to patents, patent applications, and non-patent literature are hereby incorporated by reference herein in their entirety.

Embodiments illustrating the devices, methods and systems described herein may be further understood by reference to the following non-limiting examples:

### EXAMPLES

### Example 1

Batteries of total combined weight 1100 kg were dismantled. 170 kg of sulfuric acid was recovered. The concentration of the acid was measured and found to be 20% w/v. 721 kg of metallic or metal containing components and 193 kg of non metallic components were recovered. The metallic or metal components comprise of grid materials, lead oxides and sulfates and the non metallic components comprise of separators and plastics. Some lead oxides and sulfates remain attached to the non metallic components. The following steps were used to convert the lead oxides and sulfates, attached to the non metallic components, into soluble Pb(NO₃)₂ so that it can be removed. The non metallic components were crushed in a grinder. The crushed material was washed with 200 liters of 0.5% NaOH solution at around 60° C. to convert any PbSO₄ to PbO. It was then treated with 400 liters of 5% H₂O₂ and 10% nitric acid to convert all lead oxides into soluble Pb(NO₃)₂. The Pb(NO₃)₂ containing washing liquid was then filtered out. The Pb free separators and plastics were then washed with de-mineralized water and were then sent for recycling. 9 kg of 98% concentrated sulfuric acid was then added to the Pb(NO₃)₂ containing washing liquid. 22 kg of PbSO₄ precipitate was formed and nitric acid was regenerated. 22 kg PbSO₄ obtained was mixed with the 721 kg of metallic or metal containing components previously obtained. It was then separated into metal and paste comprising lead oxides and sulfates by wet classification with a 200 mesh. 220 kg of material, the grid metal was retained in the mesh and 516 kg of material, the paste passed through the mesh. The grid metal was then dipped in 22 kg molten NaOH at 400° C. 201 kg grid metals free of lead compounds was obtained. 36 kg of dross obtained was mixed with 75 liter of DM water. 15 kg of solid PbO was obtained after filtration. The NaOH solution obtained as filtrate was used in a separate desulfurization process. The 15 kg PbO was mixed with the paste and the total paste treated 225 litres of 40% NaOH at 80° C. The reaction mixture was filtered, 441 kg of solid was retained and the filtrate was a sodium sulfate solution. The total solid was then treated with 500 liter of 30% acetic acid at 50° C. The 174 kg of undissolved solid was obtained after filtration. The filtrate was treated as described below. The filtrate was then mixed with 120 kg of 98% H₂SO₄ to precipitate PbSO₄. The solution was then filtered and 359 kg of precipitate was obtained. After washing the cake was then treated with 240 liters 40% NaOH solution. The reaction mixture was then filtered and washed with DM water. 262 kg of solid PbO obtained after filtration. The 174 kg undissolved solid remained after the previous acetic acid treatment step was treated with 250 liter 70% H₂SO₄ at 80° C. for 30 minutes. 219 kg of solid was obtained after filtration. The solid was then treated 140 litres of 40% NaOH at 80° C. 163 kg solid was obtained after filtration. The solid was then treated with 300 liters 30% acetic acid. The reaction mixture was then filtered and the filtrate was mixed with 75 kg 98% sulfuric acid. 220 kg of precipitate was obtained after filtration. The precipitate was treated with 150 liters 40% NaOH solution. 160 kg of solid was obtained after filtration. The 160 kg of solid obtained from the current NaOH treatment step was mixed the 262 kg of solid obtained from previous NaOH treatment step. The purity of the total solid was found to be 99.99% pure PbO.

### Example 2

100 kg of paste from the negative plate treated 50 liters of 35% NaOH at 80 ° C. The reaction mixture was filtered, 82 kg of solid was retained and filtrate was a sodium sulfate solution. The solid was then dissolved in 150 liter of 30% acetic acid. The solution was then treated with 50 kg of 98% sulfuric acid. PbSO₄ formed as precipitate and acetic acid was regenerated. 109 kg PbSO₄ precipitate was formed which was then filtered out. PbSO₄ precipitate was treated with 80 liters of 40% NaOH at 80° C. to convert PbSO₄ to PbO. 80 kg kg PbO was filtered out. The purity of the PbO was found to be 99.99%.

### Example 3

100 kg of paste from positive plates was treated 100 liters 5% nitric acid. Broken pieces of Pb alloys along with metallic impurities in the paste dissolve in nitric acid and forms soluble nitrates. The reaction mixture was filtered. 10 liters 10% sulfuric acid was added to the filtrate. PbSO₄ precipitate was formed and nitric acid was regenerated. 2.5 kg of PbSO₄ precipitate was filtered out. The PbSO₄ precipitate was mixed the 97 kg of unreacted PbO₂ and PbSO₄ remained from the previous step and was treated with 50 liters of 20% NaOH at xx ° C. to convert PbSO₄ to PbO. 91 kg of lead oxides was obtained after filtartion.

### Example 4

100 kg of paste from positive plate was treated with 150 liters 70% sulfuric acid at 80° C. PbO₂ in the paste got reduced and PbSO₄ was formed. 116 kg of PbSO₄ was filtered out and was treated 100 liters of 40% NaOH at 80° C. The reaction mixture was filtered, 83 kg of solid was retained and the filtrate was a sodium sulfate solution. The solid was then dissolved in 150 liters of 30% acetic acid. The solution was then treated with 45 kg of 98% sulfuric acid. PbSO₄ formed as precipitate and acetic acid was regenerated. 110 kg PbSO₄ precipitate was formed which was then filtered out. PbSO₄ precipitate was treated with 80 liters of 40% NaOH at 90° C. to convert PbSO₄ to PbO. 80 kg PbO was filtered out. The purity of the PbO was found to be 99.97%.

### Example 5

100 kg of paste from positive plate was treated with 150 liters 20% nitric acid. The solution was filtered out and 98 kg of undisssolved solid was treated with a mixture of 150 liters 15% hydrochloric acid and 24 kg of 98% sulfuric acid. 114 kg of PbSO₄ was filtered out and was treated 75 liters of 40% NaOH at 80° C. PbO precipitates out and sodium sulfate forms in the solution. 83 kg of PbO with 99.97% purity was obtained.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A process for recovering lead oxide from a component of a lead-acid battery, the process comprising:
contacting a component of the lead-acid battery with a mixture comprising a nitric acid solution to reduce at least a portion of residual lead compounds and alloys comprising the component, wherein lead in the said portion of residual lead compounds and alloys is reduced from an insoluble +4 state to a soluble +2 state to form a slurry with a lead-rich filtrate;
filtering the slurry to separate plastics and separators comprising the component from the lead-rich filtrate; and
contacting the lead-rich filtrate with sulfuric acid to obtain a lead sulfate paste and nitric acid.

2. The process of claim 1, further comprising processing the lead sulfate paste to obtain lead oxide.

3. The process of claim 1, wherein the nitric acid obtained from contacting the lead-rich filtrate with sulfuric acid is recovered and reused.

4. The process of claim 1, wherein the mixture comprises hydrogen peroxide and nitric acid.

5. The process of claim 1, the plastics and separators separated from filtering the slurry are substantially free of lead.

6. A process for recovering lead oxide from a component of a lead-acid battery, the process comprising:
processing the component to form a paste comprising sulfates of lead and other metals comprising the component;
contacting the paste comprising sulfates of lead and other metals with alkali to form a precipitate comprising oxides of lead;
contacting the precipitate comprising oxides of lead with a carboxylic acid to form soluble lead carboxylates; and
processing soluble lead carboxylates to obtain lead monoxide.

7. The process of claim 6, wherein processing the component to form a paste comprising sulfates of lead and other metals comprises contacting at least a portion of the component with sulfuric acid.

8. The process of claim 7, further comprising, prior to contacting the portion of the component with sulfuric acid:
contacting the portion of the component with nitric acid to form a filtrate comprising nitrates of lead; and
contacting the filtrate comprising nitrates of lead with an alkali to form a slag comprising oxides of lead.

9. The process of claim 6, wherein processing soluble lead carboxylates to obtain lead monoxide comprises:
contacting the soluble lead carboxylates with sulfuric acid to form a paste comprising sulfates of lead; and
contacting the paste comprising sulfates of lead with alkali to obtain lead monoxide.

10. The process of claim 9, wherein contacting the soluble lead carboxylates with sulfuric acid generates the carboxylic acid, and wherein the carboxylic acid is reused in the process.

11. The process of claim 6, wherein processing soluble lead carboxylates to obtain lead monoxide comprises:
contacting the soluble lead carboxylates with carbon dioxide to form a lead carbonate precipitate; and
heating the lead carbonate precipitate to obtain lead monoxide.

12. The process of claim 11, wherein heating the lead carbonate precipitate regenerates carbon dioxide, wherein the carbon dioxide is reused in the process.

13. A process for recovering lead oxide from a lead-acid battery, the process comprising:
contacting a first component of the lead-acid battery with a mixture comprising a nitric acid solution to reduce at least a portion of residual lead compounds and alloys comprising the first component, wherein lead in the portion of residual lead compounds and alloys is reduced from an insoluble +4 state to a soluble +2 state to form a slurry with a lead-rich filtrate;
separating plastics and separators from the lead-rich filtrate in the slurry;
contacting the lead-rich filtrate with sulfuric acid to obtain a lead sulfate paste and nitric acid;
processing a second component of the lead-acid battery to form a paste comprising sulfates of lead and other metals comprising the second component;
contacting the lead sulfate paste and the paste comprising sulfates of lead and other metals with alkali to form a precipitate comprising oxides of lead;
contacting the precipitate comprising oxides of lead with a carboxylic acid to form soluble lead carboxylates; and
processing soluble lead carboxylates to obtain lead monoxide.

14. A plant for recovering lead oxide from a component of a lead-acid battery, the plant comprising:
a first reactor having a reaction chamber for contacting the component with a mixture comprising a nitric acid solution to reduce at least a portion of residual lead compounds and alloys comprising the component, wherein lead in the portion of residual lead compounds and alloys is reduced from an insoluble +4 state to a soluble +2 state to form a slurry with a lead-rich filtrate;
a filtration system for filtering the slurry to separate plastics and separators comprising the component from the lead-rich filtrate; and
a second reactor having a sulfatation chamber for contacting the lead-rich filtrate with sulfuric acid to obtain a lead sulfate paste and nitric acid.

15. The plant of claim 14, further comprising a third reactor having a processing the lead sulfate paste to obtain lead oxide.

16. A plant for recovering lead oxide from a component of a lead acid battery, the plant comprising:
a first reactor for processing the component to form a paste comprising sulfates of lead and other metals comprising the component;
a second reactor having a hydroxylation chamber for contacting the paste comprising sulfates of lead and other metals with alkali to form a precipitate comprising oxides of lead; and
a third reactor having a carboxylation chamber for contacting the precipitate comprising oxides of lead with a carboxylic acid to form soluble lead carboxylates.

17. The plant of claim 16, further comprising a fourth reactor for processing soluble lead carboxylates to obtain lead monoxide.

18. A plant for recovering lead oxide from a lead acid battery, the plant comprising:
a first reactor having a reduction chamber for contacting a first component of the lead-acid battery with a mixture comprising a nitric acid solution to reduce at least a portion of residual lead compounds and alloys, wherein lead in the portion of residual lead compounds and alloys is reduced from an insoluble +4 state to a soluble +2 state to form a slurry with a lead-rich filtrate;
a first filtration system for filtering the slurry to separate plastics and separators comprising the first component from the lead-rich filtrate;
a second reactor having a sulfatation chamber for contacting the lead-rich filtrate and the slurry to obtain a paste comprising sulfates of lead and other metals;
a second filtration system for separating the paste comprising sulfates of lead and other metals from a suspension;
a third reactor having a hydroxylation chamber for contacting the paste comprising sulfates of lead and other metals with alkali to form a precipitate comprising oxides of lead; and
a fourth reactor having a carboxylation chamber for contacting the precipitate comprising oxides of lead with a carboxylic acid to form soluble lead carboxylates;
a fifth reactor for processing soluble lead carboxylates to obtain lead monoxide.

19. The plant of claim 15, wherein acid generated following sulfatation in the second reactor is recycled and reused in the plant.

20. The plant of claim 15, wherein acid generated following processing soluble lead carboxylates in the fifth reactor is recycled and reused in the plant.
